(19) United States
(12) Patent Application Publication
(10) Pub. No.: US 2004/0071507 A1
(43) Pub. Date: Apr. 15, 2004

(54) Reinforcing bar coupling

(76) Inventor: Yong-Keun Kim, Incheon (KR)

Correspondence Address: Peter T Kwon, Kangnam, PO Box 2301, Seoul, 135-242, KR

(21) Appl. No.: 10/467,128

(22) PCT Filed: Feb. 7, 2002
(86) PCT No.: PCT/KR02/00190

(30) Foreign Application Priority Data
Feb. 14, 2001 (KR) 2001/7181

(51) Int. Cl. B25G 3/20

(52) U.S. Cl. 403/368

(57) ABSTRACT

The object of this invention is to provide a reinforcing bar coupling used to easily, simply, quickly and mechanically butt-joint two reinforcing bars to each other for use in reinforced concrete construction. The reinforcing bar coupling consists of a cylindrical sleeve (2) axially receiving two reinforcing bars (1) through two inlets (20), with an uneven interior surface (22) formed in the sleeve (2) to correspond to the ribs (11) formed around the external surface of the bars (1). A plurality of wedges (4) are set in the gap between the bars (1) and the sleeve (2). The internal surface of the sleeve (2) and the external surface of the bars (1) with the wedges (4) are radially compressed to butt-joint the two bars (1) by the coupling.

### TECHNICAL FIELD

The present invention relates, in general, to a coupling and, more particularly, to a reinforcing bar coupling which is intended to obtain a mechanical butt-joint of ends of two reinforcing bars in reinforced concrete work to enhance strength of the coupled portion and to afford a prompt and convenient coupling operation.

### BACKGROUND ART

Since reinforcing bars are produced at certain unit lengths from factories, building works for various structures such as bridges, breast walls and apartment houses, which extend to several tens of meters in length, require ends of reinforcing bars to be overlapped. As conventional methods for jointing reinforcing bars, a few joint processes are used, which are disclosed as follows.

In the prior art, a lap-joint process, which is carried out in such a way that ends of reinforcing bars are lapped along certain lengths thereof and the lapped ends of the reinforcing bars are bound with binding wires, is predominantly used. However, the lap-joint process has disadvantages in that distances between the adjacent reinforcing bars become small at the lapped regions, required amount of reinforcing bars is increased due to the lapped regions of the reinforcing bars, a pouring operation of concrete into space between the lapped reinforcing bars is difficult due to the small distances between the adjacent reinforcing bars, and the lap-jointed reinforcing bars are weakened in resistance to axial tensile force and compressive force.

In another process, i.e., in a gas pressure welding process in which ends of reinforcing bars are butted on each other and the ends of the reinforcing bars are welded to each other by high temperature flame, a specialized technique is required to carry out the gas pressure welding process, the welded portion of the reinforcing bars is weakened by heat, and a post inspection is further required.

In a steel pipe compression process in which ends of two reinforcing bars are inserted into a steel pipe and the steel pipe containing the two ends of reinforcing bars is compressed by a hydraulic jack, though a specialized technique is not required, a special equipment is required to perform the joint operation.

Therefore, to overcome the above problems, a process for mechanically jointing two reinforcing bars is developed and used in recent years.

In other words, ends of reinforcing bars are subjected to an upsetting working, i.e., thickened and shortened by a hot or cold working, or ends of reinforcing bars are subjected to cold swaging working to cause ribs of the bars to be collapse d and to be smooth, and then threaded into male screws by a working tool such as screw thread rolling machine. Subsequently, two threaded ends of the reinforcing bars are threaded into a coupling having female threads in its inner surface, thereby obtaining jointing of two reinforcing bars.

However, the above thread-joint process also has disadvantages in that there is required many working steps to form male threads on ends of reinforcing bars, and although reinforcing bars are considerably long and apt to be bent due to material characteristics thereof, two reinforcing bars must be precisely aligned with each other to allow the ends of the reinfor cing bars to be threaded into a coupling, thereby involving convenience in a jointing operation.

### DISCLOSURE OF THE INVENTION

Accordingly, the present invention has been made keeping in mind the above problems occurring in the prior art, and an object of the present invention is to provide a reinforcing bar coupling which is capable of achieving a firm jointing between reinforcing bars by a simple operation of inserting wedges between ends of reinforcing bars and a sleeve and hammering the wedges.

In order to accomplish the above object, the present invention provides a reinforcing bar coupling, comprising: a cylindrical sleeve having a cross sectional area sufficient to accommodate two reinforcing bars entered through inlets at opposite ends thereof, and which is provided at a part of its inner surface with an uneven surface corresponding to an outer ribbed surface of the reinforcing bars; wedge means adapted to be fitted between the sleeve and the reinforcing bars to apply radial force to them, thereby achieving butt-jointing of the two reinforcing bars.

Furthermore, the present invention provides wedge means, which is configured to have a length substantially equal to that of the sleeve and to be fitted into a gap between the slee ve and the reinforcing bars, and which comprises a mediate pad adapted to be in contact with the reinforcing bars and having an uneven contact surface corresponding to an outer ribbed surface of the reinforcing bars, a gap defined between the sleeve and the mediate pad gradually becoming narrower toward the middle point of the sleeve; and two wedge elements adapted to be fitted into the gap defined between the sleeve and the mediate pad by impact from a hitting tool such as a hammer.

The reinforcing bar coupling according to the present in vention can be commonly used in jointing two reinforcing bars in new construction, rebuilding and repair work of various concrete structures such as bridges and buildings. The reinforcing bar coupling enables easy and firm coupling of reinforcing bars by a simple hitting tool. Furthermore, since reinforcing bars are coupled to each other without overlapping thereof, excessive consumption of reinforcing bars can be prevented and cost savings can be advantageously achieved. In addition, the reinforcing bar coupling exhibits superior boding strength compared to a conventional coupling method.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view of a first embodiment of the present invention;

FIG. 2 is a cross-sectional view showing an assembled condition of the first embodiment of the present invention;

FIG. 3 is a transverse cross-sectional view of the first embodiment of the present invention;

FIG. 4 is an exploded perspective view of a second embodiment of the present invention;

FIG. 5 is a cross-sectional view showing an assembled condition of the second embodiment of the present invention;

FIG. 6 is a transverse cross-sectional view of the second embodiment of the present invention;

FIG. 7 is an exploded perspective view of a third embodiment of the present invention;

FIG. 8 is a cross-sectional view showing an assembled condition of the third embodiment of the present invention;

FIG. 9 is a cross-sectional view taken along line A-A of FIG. 8;

FIG. 10 is a perspective view showing an assembled condition of the first embodiment of the present invention;

FIG. 11 is an exploded perspective view of a mediate pad according to a fourth embodiment of the present invention;

FIG. 12 is a cross-sectional view of a reinforcing bar coupling to which the mediate pad of FIG. 11 is applied; and

FIG. 13 is a transverse cross-sectional view of a reinforcing bar coupling to which the mediate pad of FIG. 11 is applied.

### BEST MODE FOR CARRYING OUT THE INVENTION

This invention will be described in further detail by way of example with reference to the accompanying drawings.

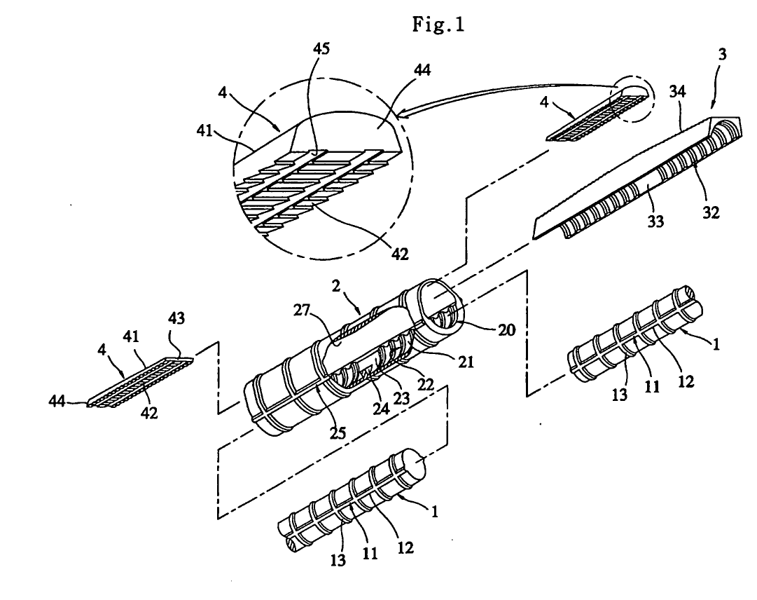

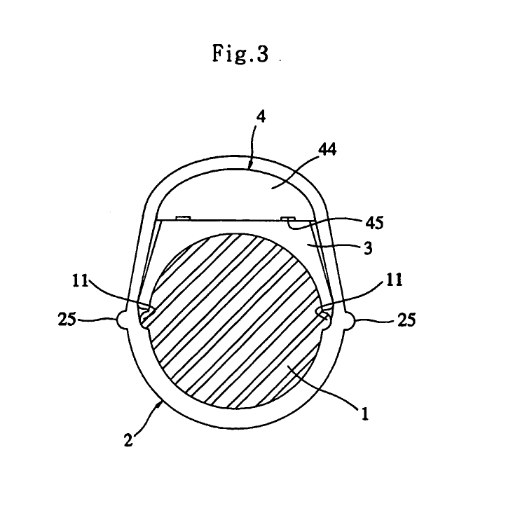

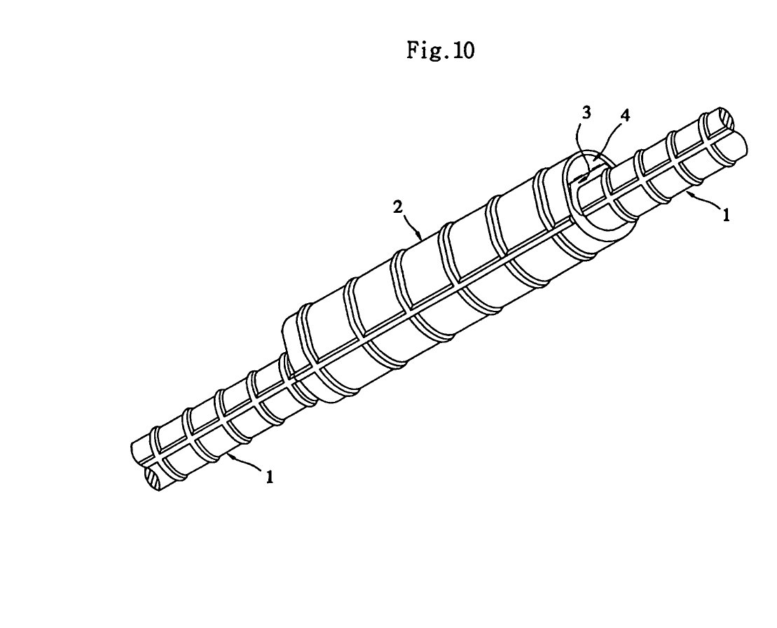

FIGS. 1 to 3 are a exploded perspective view, a cross-sectional view and a transverse cross-sectional view of a first embodiment of the present invention, in which the embodiment of the present invention comprises a sleeve 2, a mediate pad 3 and a pair of wedges 4 to joint two reinforcing bars 1. A perspective view of a reinforcing bar coupling according to the e mbodiment of the present invention is shown in FIG. 10, in which the reinforcing bar coupling is assembled.

The reinforcing bars 1, the mediate pad 3 and wedges 4 are separately inserted or pushed into inlets 20 of the sleeve 2 of a certain length. A size of the sleeve is designed according to a diameter of the reinforcing bars to be jointed. To this end, a sectional area of the sleeve 2 assumes a shape similar to an ellipse.

As is well known in the art, a reinforcing bar is evenly formed at its outer surface with ribs to improve adhesion force to concrete and strength. The sleeve 2 is provided at its inner surface with an uneven surface by grooves 21 along the length such that the grooves 21 are formed to have an arrangement corresponding to that of the ribs (or an outer shape) of reinforcing bars. With the grooves 21 formed in the inner surface of the sleeve 2, reinforcing bars cannot be axially displaced once the reinforcing bars are inserted into and engaged to the sleeve 2.

The ribs 11 consist of longitudinal ribs 12 and annular ribs 13. In some reinforcing bars, the annular ribs 13 may be alternately formed along the longitudinal ribs 12 (not shown) To accommodate for reinforcing bars having such alternate annular ribs, the annular grooves 21 are arranged such that a pitch of the adjacent annular grooves 21 formed on the uneven surface is a half as large as a pitch of adjacent annular ribs 13.

Although not shown, since there may be a convenience in inserting reinforcing bars into the sleeve such that the reinforcing bars radially coincide with each other, the sleeve 2 may be provided at its uneven surface with several longitudinal grooves. By the longitudinal grooves, the uneven surface of the sleeve will assume a lattice shape. A contact angle between an outer surface of a reinforcing bar and the uneven surface 22 of the sleeve or an inner surface of the mediate pad may be of 90°-180°, but the contact angle is not necessarily limited to that.

Although a reinforcing bar 1 may be formed at its cut end with burrs or may be uneven at its outer surface to be changed in its diameter, the uneven surface 22 of the sleeve is adapted to be in close contact with the reinforcing bar. This can be achieved in such a way that an inner diameter of a certain middle section of the sleeve (corresponding to a portion at which ends of reinforcing bars are positioned) is more enlarged than that of the remaining inner surface to form an enlarged inner surface. That is, though burrs or deformed portions of ends of reinforcing bars are positioned at the enlarged inner surface, close contact between the reinforcing bars and the sleeve is not interrupted.

Furthermore, so as to limit inserted lengths of reinforcing bars 1 into the sleeve 2, the sleeve is provided at its in ner middle portion with a semicircular stopper 24.

An inner slant face 27 of the sleeve which faces the uneven surface 22 is gradually reduced in its inner diameter from the both ends to the middle point in order to intensify driving action of the wedges. Details relating to this will be more specifically described hereinafter.

The sleeve 2 is formed at its outer surface with longitudinal and annular ribs 25 similar to ribs 11 of reinforcing bar s 1 provided to improve cohesiveness with concrete.

The mediate pad 3 is comprised of a semi-cylinder having a length corresponding to that of the sleeve 2, and includes a t its inner surface an uneven surface 32 having a shape and a function similar to those of the uneven surface of the sleeve, thereby enabling the other half surfaces of the reinforcing bars to be in close contact therewith. The mediate pad 3 is gradually thickened toward its middle portion to assume a symmetrical contour tapered outward. An angle of inclination of the outer slant surface of the mediate pad is set to achieve a desired correlation with the sleeve and the wedges. As is the case with the sleeve, the mediate pad 3 is provided at its inner middle portion with an enlarged surface 33, which is formed to accommodate undesirable burrs etc., of reinforcing bars.

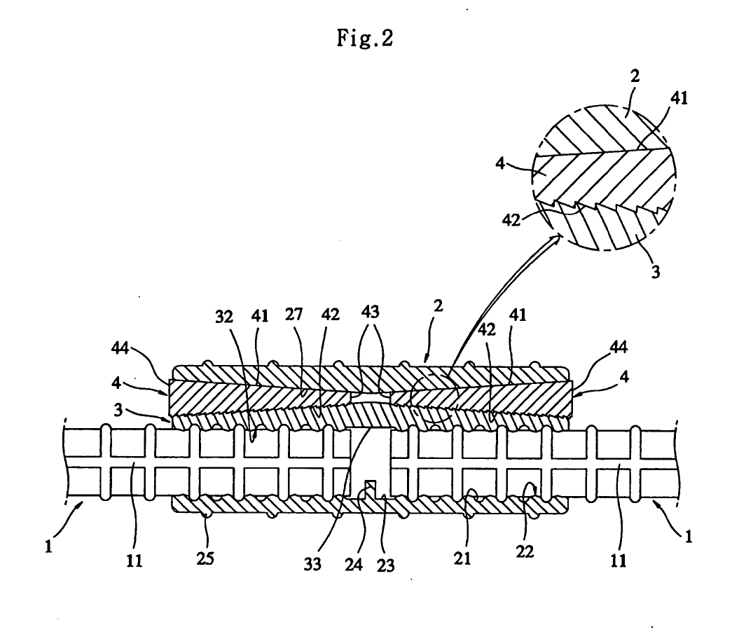

Moreover, an outer surface of the mediate pad is symmetrically provided with a serration. The serration serves as blocking means for preventing the wedges 4 from sliding out between the mediate pad 3 and the sleeve 2 once the wedges 4 are fitted between the mediate pad 3 and the sleeve 2, as shown in FIG. 2. Functions and configuration of the serration are the same in all of after-mentioned embodiments. The serration serves to prevent slippage of the wedges, and the shape of the serration is not limited to that shown in the drawings.

The wedges 4 are rectangular plates, each of which includes an end being thinner than the other end. A pair of wedges 4 are fitted into the inlets 20 of the opposite ends of the sleeve. Each of the wedges 4 is configured such that its upper surface 41 conforms to the inner slant face 27 of the sleeve 2 and its lower surface conforms to the outer surface 34 of the mediate pad 3. In other words, the lower surface 42 of the wedge is provided with a serration corresponding to the serration of the outer surface 34 of the mediate pad 3.

As is well known, the wedge has a shape and a function similar to those of a commonly used wedge. A rear end 44 of the wedge is more enlarged than a front end 43, and serves to be hit with a hitting tool such as a hammer.

An overall length of the wedge 4 is slightly shorter than a half of an overall length of the sleeve 2. The wedge may be optionally provided with one or more longitudinal grooves 45 without the serration to reduce frictional resistance to the mediate pad 3 during its fitting. The longitudinal grooves 45 may be provided at its one surface or its both surfaces. Such longitudinal grooves may also be formed at the mediate pad or the sleeve.

Functions of the first embodiment of the present invention will be described in assembling order.

First, two reinforcing bars to be jointed are inserted into the sleeve 2 through both ends of the sleeve such that the ribs 11 of the reinforcing bars 1 are in close contact with the uneven surface 22 of the sleeve 2 and the ends of the reinforcing bars are positioned at the enlarged portion. Subsequently, the mediate pad 3 is fully inserted into the sleeve 2 so that the mediate pad comes into close contact with the ribs 11 of the reinforcing bars. After two wedges 4 are temporarily fitted between the mediate 3 and the sleeve 2 though both ends of the sleeve 2, the wedges are strongly hit with a hitting tool such as a hammer.

By the hitting of the hammer, the inner slant face 27 of the sleeve 2 and the outer surface of the reinforcing bars 1 are applied with strong radial pressure via the mediate pad 3. That is, a firmly engaged condition of the components is achieved by action of the wedges. Furthermore, since the wedges a nd the mediate pad are engaged with each other by the serration formed thereat, the wedges cannot slide out of the sleeve even if the sleeve is applied with vibration or external force. Moreover, even though strong external tensile force acts on the sleeve, the engaged condition of the reinforcing bars is no t broken by the uneven surfaces 22, 32 of the sleeve and the mediate pad engaged with the ribs 11 of the reinforcing bars.

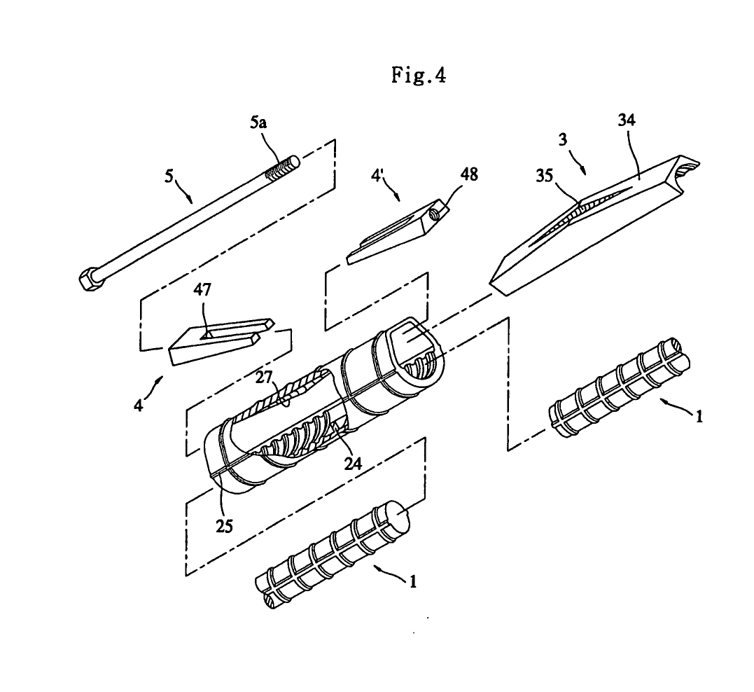

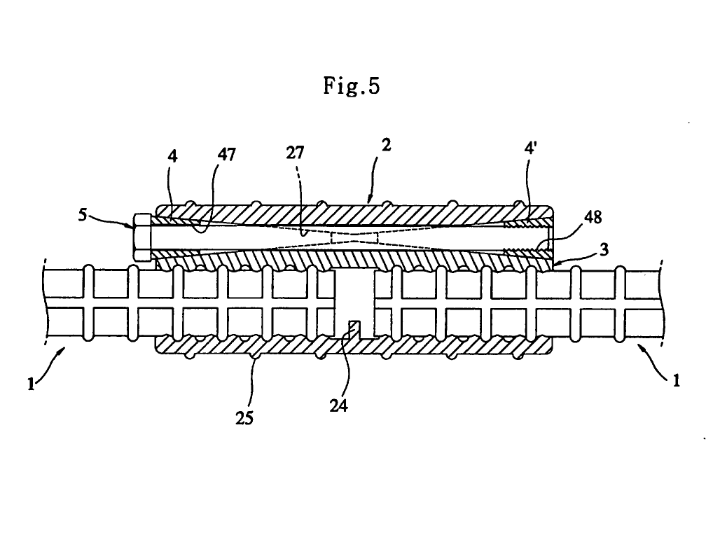

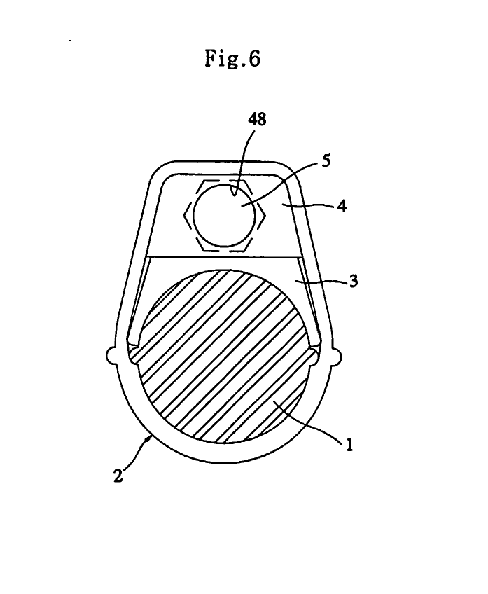

FIGS. 4 to 6 show a second embodiment of the present invention. An essential configuration of the second embodiment is substantially equal to that of the first embodiment, except that wedges 4, 4′ are driven into the sleeve by a bolt 5 rather than the hitting force of a hammer. That is, one 4 of a pair of wedges is formed with a longitudinal bolt through hole 47, and the other 4′ of the pair of wedges is formed with a longitudinal female threaded hole 48, which is adapted to be engaged with a male threaded portion 5a of the bolt 5.

The bolt 5 has a diameter suitable to a size of reinforcing bars 1 to be jointed. To reduce a longitudinal cross sectional area, each of the wedges 4, 4′ is shaped as a “U”-shaped clamp in plan, as illustrated in FIG. 4. The mediate pad 3 is provided at its outer slant surface with a longitudinal groove 35 to allow the bolt 5 to pass therethrough. Therefore, the sleeve 2 can be reduced in its cross sectional area. In arrangement of a plurality of reinforcing bars, it is generally known that it is preferable to reduce a cross section of the sleeve in terms of a building operation and strength of a beam.

A modification which can be derived from this embodiment is configured such that the bolt 5 is longitudinally elongated to fully pass through a wedge 4′ with its male threaded end 5a protruded from the wedge and the threaded end of the bolt is screwed into a nut (not shown). In this case, a seat face a nd/or seat faces of the bolt and/or the nut can be of course provided with a common washer.

As described above, functions of the second embodiment of the present invention are substantially equal to those of the first embodiment of the present invention. However, this embodiment is different from the first embodiment only in that the wedges 4 are driven into the sleeve by fastening action of the bolt 5 between the female threaded hole 48 of the wedge 4′ or a nut (not shown) rather than by hitting action of a hammer.

Another modification which can be derived from this embodiment is designed to employ a complex action of hitting of a hammer and fastening of a bolt and a nut. In other words, the wedges 4 are first driven into a sleeve by hitting of a hammer and then fastened by the bolt 5. Since this modification can be fulfilled by designing to adjust angles of inclination of the wedges and the mediate pad, detailed description thereof is omitted.

The method of coupling reinforcing bars according to the embodiment of the present invention can be advantageously applied to an operation of coupling new reinforcing bars to existing reinforcing bars 1 which are previously arranged or to existing reinforcing bars 1 which are embedded in poured concrete where adhesive force between the existing reinforcing bars and the concrete may be weakened by impact shocks acting on the wedges.

The stopper 24, the ribs 25 and the inner slant face 27 of this embodiment have the same shapes and functions as those of the first embodiment.

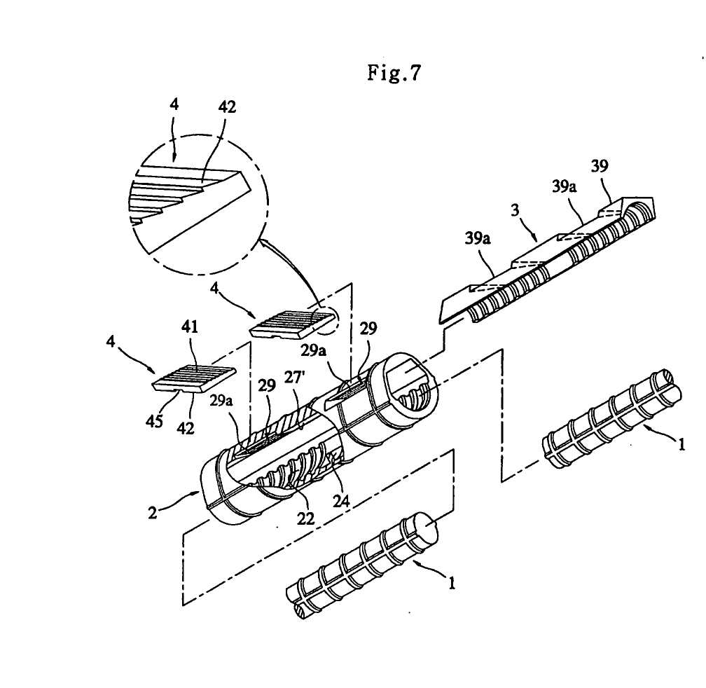

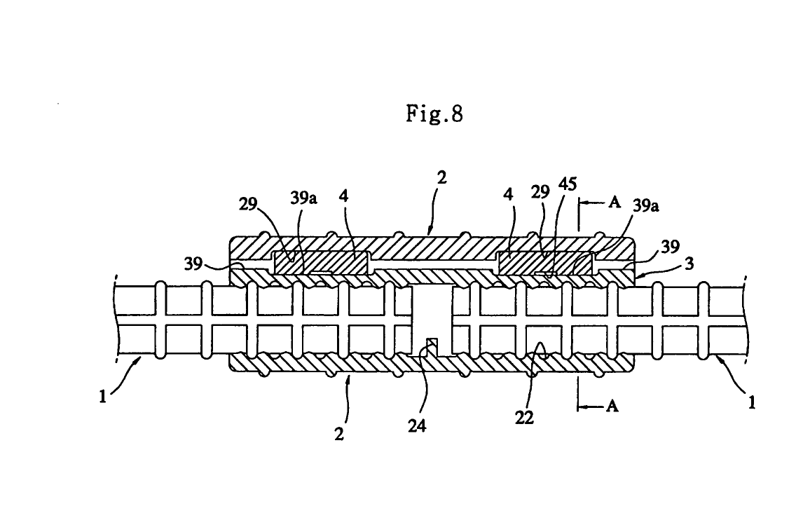

FIGS. 7 to 9 show a third embodiment of the present invention. An essential configuration of this third embodiment is substantially equal to that of the first and second embodiment s, except that a fitting direction of wedges 4 is perpendicular to reinforcing bars. To this end, a sleeve 2 is formed with two wedge fitting openings 29, which are directed to be perpendicular to reinforcing bars. Furthermore, a mediate pad 3 is formed at its upper surface 39 with two wedge seat grooves 39 a, which are located at positions corresponding to those of the wedge fitting openings 29, and each of which has a width equal to or larger than a width of the wedge 4.

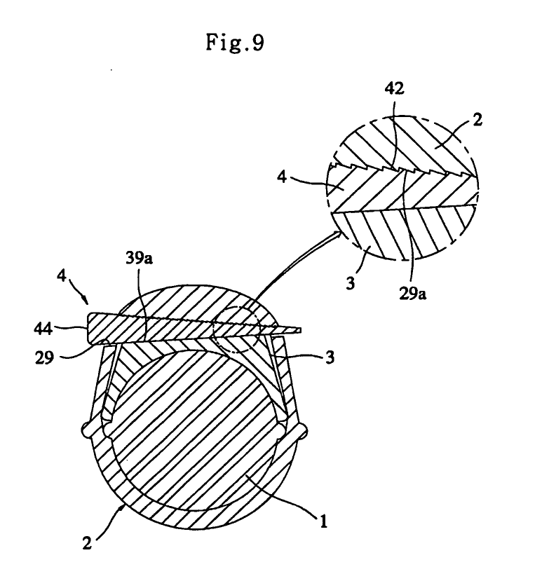

As shown in FIG. 9, upper surfaces 41 of the wedges 4 and upper surfaces 29a of the wedge fitting openings 29 of the sleeve 2 have serrated surfaces corresponding to each other. The serration serves to prevent the wedges from sliding out of the sleeve.

A fitting manner and other details of this embodiment are substantially identical to those of the previous embodiments. That is, the stopper 24 and the uneven surface etc., of the sleeve 2 are identical to those of the previous embodiments in functions and shapes.

The characteristics of this embodiment are as follows. Widths of the wedge fitting openings 29 of the sleeve 2 and widths of the wedge seat grooves 39a of the mediate pad 3 are set to be slightly larger than a width of the wedge 4. Accordingly, even though axial positions of annular ribs 13 of a reinforcing bar are alternately arranged along longitudinal ribs 1 2 or irregularly arranged so that the wedge fitting openings 2 9 of the sleeve 2 are not aligned with the wedge seat faces 39 a of the mediate pad 3, the wedges 4 can be easily fitted into the sleeve. In addition, corners of the wedge fitting openings 29 are rounded to prevent possibility of cracking of the sleeve 2 during fitting of the wedges.

A reference numeral “45” designates a groove provided to reduce resistance during a fitting operation of the wedges, and a reference numeral “44” designates a rear end to be hit by a hitting tool of a user.

A modification which can be derived from this embodiment of the present invention is configured such that the two wedges are integrally formed. In this modification, since fitting directions of the two wedges are identical to each other and fitting positions of the wedges are adjacent to each other, the two wedges are integrally connected to each other to form a U-shaped clamp to permit the two wedges to be fitted concurrently.

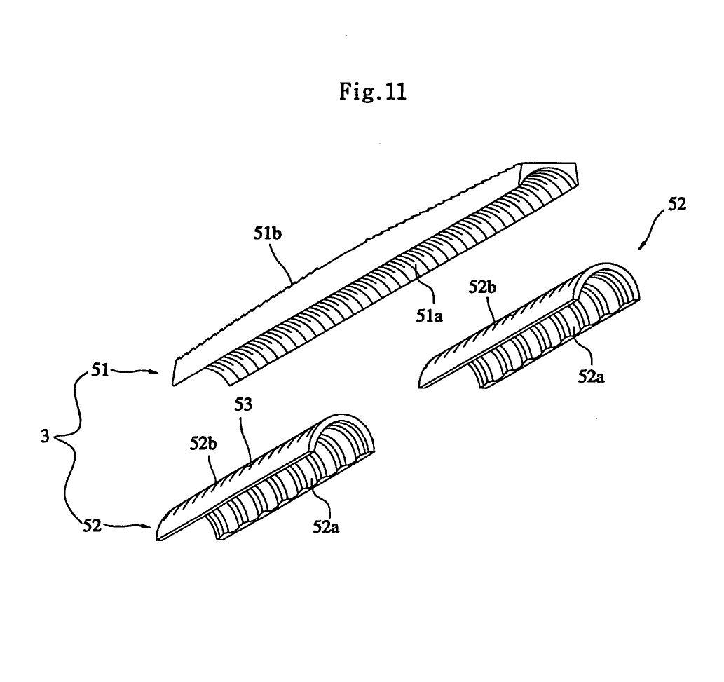

Referring to FIGS. 11 to 13, there are shown a fourth embodiment of the present invention. This embodiment is designed to be applied in the case where shapes and positions of annular ribs formed on outer surfaces of reinforcing bars produced by various manufacturers are different from one another. That is, where grooves of an uneven surface of a mediate pad do not coincide with annular ribs of a reinforcing bar in position, the contact surface between the mediate pad and the reinforcing bar is reduced. To accommodate such a nonconformity between the grooves of the mediate pad and the annular ribs of the reinforcing bars, this embodiment is intended to allow the mediate pad to be slightly displaced to conform to the reinforcing bar.

To this end, the mediate pad 3 is comprised of two sub mediate pads, as shown in FIG. 11. In other words, the mediate pad 3 is comprised of a first mediate pad 51 and a pair of second mediate pads 52. The second mediate pads 52a are provided at lower surfaces thereof with uneven surfaces corresponding to an outer surface of a reinforcing bar. The first and second mediate pads are provided at facing surfaces thereof with serration surfaces 51a, 52b having triangular screw threads so that the first and second mediate pads are engaged with each other by the serration surfaces 51a, 52b. The second mediate pads can be maintained to be attached to the first mediate pad by means of magnets mounted on the second mediate pads. As such, since the second mediate pads are provided with the magnets, components required to joint reinforcing bars can be reduced, thereby facilitating maintenance and a jointing operation of the coupling.

An upper surface 51b of the first mediate pad is provided with a serrated surface for preventing sliding of the wedges 4, as is the case with the previous embodiments.

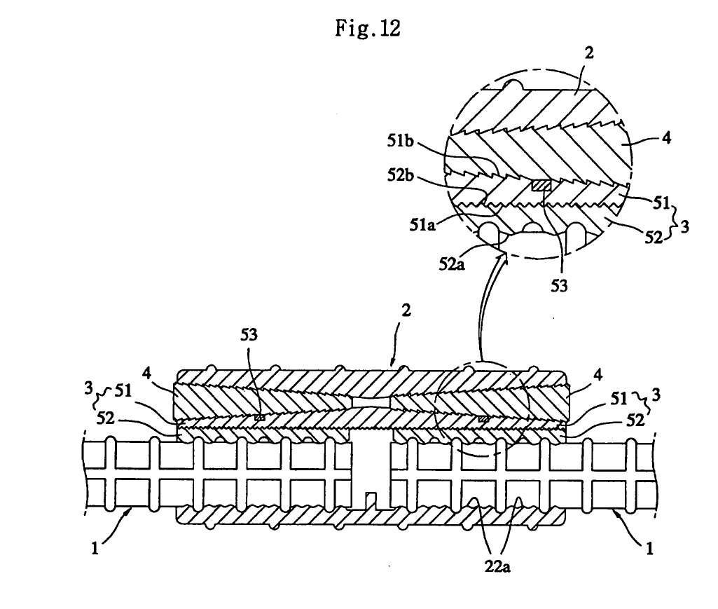

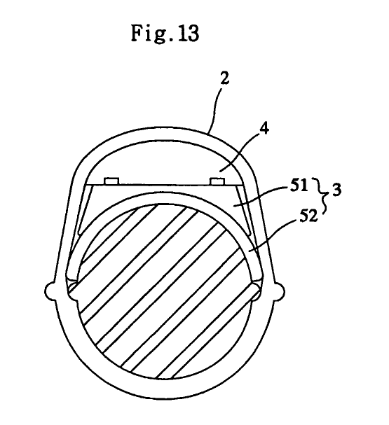

FIGS. 12 and 13 are a cross-sectional view and a transverse cross-sectional view showing the mediate pads used in joint ing reinforcing bars.

Two reinforcing bars are first inserted into the sleeve, and the first and second mediate pads are inserted thereinto. Then, the second mediate pads are adjusted in their longitudinal positions to conform to outer surfaces of the reinforcing bars. Thereafter, the wedges 4 are driven into the sleeve by a hitting action of a hammer to complete a coupling operation of the reinforcing bars.

In this embodiment, although two second mediate pads are shown in FIGS. 11 and 12 to be disposed at both sides of the sleeve, one second mediate pad may be disposed at only one side of the sleeve. That is, one second mediate pad may be disposed under a side of the first mediate pad.

According to the embodiment shown in FIG. 12, each of the wedges is provided at both of its upper and lower surfaces with serrated surfaces, and the sleeve is also provided at its upper surface with a serrated surface. As such, the serrated surfaces may be selectively formed at either one or both of upper and lower surfaces of the wedge.

The sleeve 2, which directly comes into contact with a reinforcing bar, is provided at its lower surface with ridges 2 2a like screw threads in order to intensify compressing action to the reinforcing bars by fitting of wedges. The ridges can be applied to all the previous embodiments as well as this embodiment.

In still another embodiment of the present invention, reinforcing bars can be jointed using only the sleeve and the wedges without the mediate pad. Those skilled in the art will a ppreciate that this embodiment can be derived from a basic idea of the present invention with reference to the above embodiment.

The components of the reinforcing bar coupling are preferably made from material having strength equal to or higher than that of reinforcing bars to be jointed, so as to sufficiently resist tensile force or compression force acting on a ferro concrete building incorporating the coupling. As material which can be used, any one of cast steel, steel, stainless steel, soft iron and synthetic resin can be selected in consideration of service condition, production cost and so on.

As such, the reinforcing bar coupling according to the present invention is capable of jointing reinforcing bars in various ways. Those skilled in the art will appreciate that various modifications, additions and substitutions are possible with reference to the above embodiments without departing from the scope and spirit of the invention.

### INDUSTRIAL APPLICABILITY

As described above, though a reinforcing bar coupling according to the present invention is mainly used in such a way that wedges are driven into a sleeve by hitting action of a hammer, the wedges may be fastened by bolts using a fastening to ol such as a spanner if required. Therefore, a coupling operation of reinforcing bars is facilitated. Furthermore, a site work becomes convenient owing to reduction of the number of components, and wedges cannot slide out of a sleeve, due to engagement between serrated surfaces of wedges and a sleeve. The disclosed reinforcing bar coupling can be used in jointing two reinforcing bars in new construction, rebuilding and repair work of various concrete structures, such as bridges and buildings.

1. A reinforcing bar coupling, comprising:
a cylindrical sleeve having a cross sectional area sufficient to accommodate two reinforcing bars entered through inlets at opposite ends thereof, and which is provided at a part of its inner surface with an uneven surface corresponding to a n outer ribbed surface of the reinforcing bars;
wedge means adapted to be fitted between the sleeve and the reinforcing bars to apply radial force to them, thereby achieving butt-jointing of the two reinforcing bars.

2. The reinforcing bar coupling as set forth in claim 1, wherein the sleeve is provided at its inner middle portion with a stopper for limiting inserting depths of the reinforcing bars.

3. The reinforcing bar coupling as set forth in claim 1, wherein the sleeve is provided at its inner middle portion with a space for accommodating protrusions such as burrs of ends of the reinforcing bars.

4. The reinforcing bar coupling as set forth in claim 1, wherein the wedge means is configured to have a length substantially equal to that of the sleeve and to be fitted into a gap between the sleeve and the reinforcing bars, and th e wedge means comprises a mediate pad adapted to be in contact with the reinforcing bars and having an uneven contact surface corresponding to an outer ribbed surface of the reinforcing bars, a gap defined between the sleeve and the mediate pad gradually becoming narrower toward the middle point of the sleeve; and two wedge elements adapted to be fitted into the gap defined between the sleeve and the mediate pad by impact from a hitting tool such as a hammer.

5. The reinforcing bar coupling as set forth in claim 1, wherein the sleeve is provided at its outer surface with annular ribs and longitudinal ribs similar to ribs of the reinforcing bars to improve adhesion force to concrete.

6. The reinforcing bar coupling as set forth in claim 4, wherein each of the wedge elements is provided at its at least one surface with a serration, and another serration which is engaged with the serration of the wedge element is provided at a surface of the mediate pad or an inner surface of the sleeve.

7. The reinforcing bar coupling as set forth in claim 6, wherein each of the wedge elements is provided at its one or both surfaces with one or more groove lines of certain width to reduce friction resistance during fitting of the wedge element.

8. The reinforcing bar coupling as set forth in claim 4, wherein one of the two wedge elements is formed with a longitudinal through hole through which a shank of a bolt passes, and the other of the two wedge elements is formed with a longitudinal female threaded hole with which a threaded end of the bolt is engaged, whereby the two wedge elements are fitted between the sleeve and the mediate pad while coming close to each other by fastening action of a bolt and the longitudinal female threaded hole of the wedge element.

9. The reinforcing bar coupling as set forth in claim 4, wherein each of the two wedge elements is formed with a longitudinal through hole through which a shank of a bolt passes, whereby the two wedge elements are fitted between the sleeve and the mediate pad while coming close to each other by fastening action of a bolt and a nut.

10. The reinforcing bar coupling as set forth in claim 4, wherein the mediate pad comprises a first mediate pad and a second mediate pad, which are attached to each other by a magnet disposed therebetween, and the second mediate pad is provided at its inner surface with an uneven surface corresponding to an outer surface of the reinforcing bars, the first and second mediate pads being engaged with each other by serrations formed at contact surfaces thereof, whereby a position of the s econd mediate pad relative to the sleeve is precisely adjusted.

11. The reinforcing bar coupling as set forth in claim 4, wherein the uneven surface of the second mediate pad, which is in contact with reinforcing bars, includes a plurality of grooves having a pitch equal to half of a pitch of the annular ribs of the reinforcing bars.

12. The reinforcing bar coupling as set forth in claim 4, wherein the uneven surface of the sleeve, which is in direct contact with the outer surface of the reinforcing bars, includes a plurality of ridges to compress the outer surface of the reinforcing bars.

13. The reinforcing bar coupling as set forth in claim 1, wherein the wedge means is configured to have a length substantially equal to that of the sleeve and to be fitted into a gap between the sleeve and the reinforcing bars, and the wedge means comprises a mediate pad adapted to be in contact with the reinforcing bars and having an uneven contact surface corresponding to an outer ribbed surface of the reinforcing bars; two wedge fitting openings formed at the sleeve to be perpendicular to the reinforcing bars inserted in the sleeve and becoming narrower inside; and two wedge elements adapted to be fitted into the wedge fitting openings of the sleeve by impact of a hitting tool such as a hammer.

14. The reinforcing bar coupling as set forth in claim 1 3, wherein the two wedge elements are connected to each other at outer ends thereof to form a U-shaped clamp.
